(19) United States
(12) Patent Application Publication
(10) Pub. No.: US 2016/0050372 A1
(43) Pub. Date: Feb. 18, 2016

(54) SYSTEMS AND METHODS FOR DEPTH ENHANCED AND CONTENT AWARE VIDEO STABILIZATION

(71) Applicant: QUALCOMM Incorporated, San Diego, CA (US)

(72) Inventors: Albrecht Johannes Lindner, La Jolla, CA (US); Kalin Mitkov Atanassov, San Diego, CA (US); Sergiu Radu Goma, San Diego, CA (US)

(21) Appl. No.: 14/689,866

(22) Filed: Apr. 17, 2015

Related U.S. Application Data
(60) Provisional application No. 62/038,158, filed on Aug. 15, 2014.

(51) Int. Cl. H04N 5/232; H04N 13/02; G06T 7/00

(52) U.S. Cl. CPC H04N 5/23267; G06T 7/0051; H04N 13/0203; G06T 7/0042; H04N 5/23293

(57) ABSTRACT

Systems and methods for depth enhanced and content aware video stabilization are disclosed. In one aspect, the method identifies keypoints in images, each keypoint corresponding to a feature. The method then estimates the depth of each keypoint, where depth is the distance from the feature to the camera. The method selects keypoints of within a depth tolerance. The method determines camera positions based on the selected keypoints, each camera position representing the position of the camera when the camera captured one of the images. The method determines a first trajectory of camera positions based on the camera positions, and generates a second trajectory of camera positions based on the first trajectory and adjusted camera positions. The method generates adjusted images by adjusting the images based on the second trajectory of camera positions.

### CROSS REFERENCE TO RELATED APPLICATIONS

This application claims the benefit of U.S. Provisional Patent Application No. 62/038,158, entitled “DEPTH ENHANCED AND CONTENT AWARE VIDEO STABILIZATION,” filed on Aug. 15, 2014, which is hereby incorporated by reference in its entirety.

### TECHNICAL FIELD

This disclosure generally relates to video stabilization, and more specifically to systems and methods for removing jitter from video using depth information of the scene.

### BACKGROUND

Video images captured using hand held imaging systems (e.g., cameras, cellphones) may include artifacts caused by jitter and other movements of the imaging systems. Video stabilization systems and methods may reduce jitter artifacts in various ways. For example, some systems may estimate the position of the camera while it is capturing video of a scene, determine a trajectory of the camera positions, smooth the trajectory to remove undesired jitter or motion while retaining desired motion such as smooth panning or rotation, and then re-render the video sequence according to the smoothed camera trajectory.

However, existing video stabilization methods that rely on three dimensional (3D) reconstruction of the scene and camera position can be computationally intensive and therefore slow. Other methods of estimating camera trajectory relative to a scene that are less computationally expensive use two dimensional transforms and are only valid for coplanar points. Methods using two dimensional similarity transforms are even less robust for scenes with variable depth. Therefore, there is a need for video stabilization systems and methods that are less computationally expensive than three dimensional reconstruction and that are robust to depth variations in a scene.

### SUMMARY

A summary of examples of features and aspects of certain embodiments of innovations in this disclosure follows.

Methods and apparatuses or devices being disclosed herein each have several aspects, no single one of which is solely responsible for its desirable attributes. Without limiting the scope of this disclosure, for example, as expressed by the claims which follow, its more prominent features will now be discussed briefly. After considering this discussion, and particularly after reading the section entitled “Detailed Description of Certain Embodiments” one will understand how the features being described provide advantages that include reducing jitter in video.

One innovation is an imaging apparatus. The imaging apparatus may include a memory component configured to store a plurality of images, and a processor in communication with the memory component. The processor may be configured to retrieve a plurality of images from the memory component. The processor may be further configured to identify candidate keypoints in the plurality of images, each candidate keypoint depicted in a scene segment that represents a portion of the scene, each candidate keypoint being a set of one or more pixels that correspond to a feature in the scene and that exists in the plurality of images. The processor may be further configured to determine depth information for each candidate keypoint, the depth information indicative of a distance from a camera to the feature corresponding to the candidate keypoint. The processor may be further configured to select keypoints from the candidate keypoints, the keypoints having depth information indicative of a distance from the camera within a depth tolerance value. The processor may further be configured to determine a first plurality of camera positions based on the selected keypoints, each one of the first plurality of camera positions representing a position of the camera when the camera captured one of the plurality of images, the first plurality of camera positions representing a first trajectory of positions of the camera when the camera captured the plurality of images. The processor may be further configured to determine a second plurality of camera positions based on the first plurality of camera positions, each one of the second plurality of camera positions corresponding to one of the first plurality of camera positions, the second plurality of camera positions representing a second trajectory of adjusted camera positions. The processor may be further configured to generate an adjusted plurality of images by adjusting the plurality of images based on the second plurality of camera positions.

For some implementations, the imaging apparatus further includes a camera capable of capturing the plurality of images, the camera in electronic communication with the memory component.

For some implementations, the processor is further configured to determine the second plurality of camera positions such that the second trajectory is smoother than the first trajectory. For some implementations, the processor is further configured to store the adjusted plurality of images.

For some implementations, the apparatus also includes a user interface including a display screen capable of displaying the plurality of images. For some implementations, the user interface further comprises a touchscreen configured to receive at least one user input. For some implementations, the processor is further configured to receive the at least one user input and determine the scene segment based on the at least one user input.

For some implementations, the processor is further configured to determine the scene segment based on content of the plurality of images. For some implementations, the processor is further configured to determine the depth of the candidate keypoints during at least a portion of the time that the camera is capturing the plurality of images. For some implementations, the camera is configured to capture stereo imagery. For some implementations, the processor is further configured to determine the depth of each candidate keypoint from the stereo imagery. For some implementations, the candidate keypoints correspond to one or more pixels representing portions of one or more objects depicted in the plurality of images that have changes in intensity in at least two different directions.

For some implementations, the processor may be further configured to determine the relative position of a first image of the plurality of images to the relative position of a second image of the plurality of images via a two dimensional transformation using the selected keypoints of the first image and the second image. For some implementations, the two dimensional transformation is a transform having a scaling parameter k, a rotation angle φ, a horizontal offset tₓ and a vertical offset t_{y}.

For some implementations, determining the second trajectory of camera positions comprises smoothing the first trajectory of camera positions.

Another innovation is a method of stabilizing video. In various embodiments the method may include capturing a plurality of images of a scene with a camera. The method may further include identifying candidate keypoints in the plurality of images, each candidate keypoint depicted in a scene segment that represents a portion of the scene, each candidate keypoint being a set of one or more pixels that correspond to a feature in the scene and that exist in the plurality of images. The method may further include determining depth information for each candidate keypoint. The method may further include selecting keypoints from the candidate keypoints, the keypoints having depth information indicative of a distance from the camera within a depth tolerance value. The method may further include determining a first plurality of camera positions based on the selected keypoints, each of the first plurality of camera positions representing a position of the camera when the camera captured one of the plurality of images, the first plurality of camera positions representing a first trajectory of positions of the camera when the camera captured the plurality of images. The method may further include determining a second plurality of camera positions based on the first plurality of camera positions, each one of the second plurality of camera positions corresponding to one of the first plurality of camera positions, the second plurality of camera positions representing a second trajectory of adjusted camera positions. The method may further include generating an adjusted plurality of images by adjusting the plurality of images based on the second trajectory of camera positions.

Another innovation is an imaging apparatus. The apparatus may include means for capturing a plurality of images of a scene with a camera. The apparatus may include means for identifying candidate keypoints in the plurality of images, each candidate keypoint depicted in a scene segment that represents a portion of the scene, each candidate keypoint being a set of one or more pixels that correspond to a feature in the scene and that exists in the plurality of images. The apparatus may include means for determining depth information for each candidate keypoint. The apparatus may include means for selecting keypoints from the candidate keypoints, the keypoints having depth information indicative of a distance from the camera within a depth tolerance value. The apparatus may include means for determining a first plurality of camera positions based on the selected keypoints, each of the first plurality of camera positions representing a position of the camera when the camera captured one of the plurality of images, the first plurality of camera positions representing a first trajectory of positions of the camera when the camera captured the plurality of images. The apparatus may include means for determining a second plurality of camera positions based on the first plurality of camera positions, each one of the second camera positions corresponding to one of the first plurality of camera positions, the second plurality of camera positions representing a second trajectory of adjusted camera positions. The apparatus may include means for generating an adjusted plurality of images by adjusting the plurality of images based on the second plurality of camera positions.

Another innovation is a non-transitory computer-readable medium storing instructions when executed that, when executed, perform a method. The method may include capturing a plurality of images of a scene with a camera. The method may include identifying candidate keypoints in the plurality of images, each candidate keypoint depicted in a scene segment that represents a portion of the scene, each candidate keypoint being a set of one or more pixels that correspond to a feature in the scene and that exists in the plurality of images. The method may include determining depth information for each candidate keypoint. The method may include selecting keypoints from the candidate keypoints, the keypoints having depth information indicative of a distance from the camera within a depth tolerance value. The method may include determining a first plurality of camera positions based on the selected keypoints, each of the first plurality of camera positions representing a position of the camera when the camera captured one of the plurality of images, the first plurality of camera positions representing a first trajectory of positions of the camera when the camera captured the plurality of images. The method may include determining a second plurality of camera positions based on the first plurality of camera positions, each one of the second plurality of camera positions corresponding to one of the first plurality of camera positions, the second plurality of camera positions representing a second trajectory of adjusted camera positions. The method may include generating an adjusted plurality of images by adjusting the plurality of images based on the second plurality of camera positions.

### BRIEF DESCRIPTION OF THE DRAWINGS

FIG. 1 is a block diagram illustrating an example of an embodiment of an imaging system that stabilizes video using depth enhanced and content aware video stabilization.

FIG. 2 is a flow chart that illustrates an example of a method for video stabilization.

FIG. 3 illustrates an example of a scene segment selected for video stabilization.

FIG. 4 illustrates an example image frame of a video illustrating candidate keypoints.

FIG. 5 illustrates an example of a depth map corresponding to the image in FIG. 4.

FIGS. 6A-6E are examples of frames of an image captured in video, including a start frame, three consecutive frames, and an end frame.

FIG. 7 illustrates the frames shown in FIGS. 6A-6E overlaid on the scene.

FIG. 8 illustrates the trajectory of a camera that captured the frames in FIG. 7, with jitter.

FIG. 9 illustrates the trajectory of the camera that captured the frames in FIG. 7 with jitter, and a smoothed trajectory after video stabilization.

FIG. 10 illustrates the trajectory of the camera that captured the frames in FIG. 7 with jitter, and the smoothed trajectory after video stabilization superimposed on the image scene.

FIG. 11 illustrates the smoothed trajectory of FIG. 9, before the frames are rendered to the smoothed trajectory. The center points of the frames are in some cases offset from the trajectory.

FIG. 12 illustrates the re-rendered frames along the smoothed trajectory. After rendering, the center points of the frames are on the smoothed trajectory.

FIG. 13 is a flowchart that illustrates an example of a process for video stabilization according to the embodiments described herein.

### DETAILED DESCRIPTION OF CERTAIN EMBODIMENTS

The following detailed description is directed to certain specific embodiments of the invention. However, the invention can be embodied in a multitude of different ways. It should be apparent that the aspects herein may be embodied in a wide variety of forms and that any specific structure, function, or both being disclosed herein is merely representative. Based on the teachings of this disclosure, a person having ordinary skill in the art will appreciate that an aspect disclosed herein may be implemented independently of any other aspects and that two or more of these aspects may be combined in various ways. For example, an apparatus may be implemented, or a method may be practiced, using any number of the aspects set forth herein. In addition, such an apparatus may be implemented or such a method may be practiced using other structure, functionality, or structure and functionality in addition to or other than one or more of the aspects set forth herein.

Further, the systems and methods described herein may be implemented on a variety of different computing devices that include an imaging system. Such devices may include, for example, mobile communication devices (for example, cell phones), tablets, cameras, wearable computers, personal computers, photo booths or kiosks, personal digital assistants and mobile internet devices. They may use general purpose or special purpose computing system environments or configurations. Examples of computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

Video stabilization systems and methods may reduce jitter and camera motion artifacts in video images captured using hand-held portable devices. For example, video stabilization (of a series of images) may be performed by determining places in the images that have a similar depth (referred to herein as “keypoints”). That is, keypoints are points in the images of objects that are located at approximately the same distance from the imaging device. The keypoints are determined to be used in a two dimensional transform, and they are at approximately the same depth in the scene so that the transform is accurate. Estimates of camera positions are determined, and a camera trajectory of the camera positions when the camera captured the video is generated. The camera trajectory can then be smoothed to remove undesired jitter or motion artifacts while retaining desired motion (e.g., panning and/or rotation) and then adjusted video frames can be rendered based on the smoothed camera trajectory. The adjusted video frames will appear more stable and can be saved for additional processing or viewing.

Homography (or homographies), as referred to herein, is a broad term that is generally used in reference to two dimensional transforms of visual perspective. For example, homography can be used to estimate (or model) a difference in appearance of two planer objects (scenes) viewed from different points of view. Processes using two dimensional (2D) transforms can be less robust for scenes having objects at various depths. Processes using three dimensional (3D) transforms may be used in scenes having objects at various depths, but such 3D transforms are typically computationally expensive resulting in longer processing times when processing a series of video images for video stabilization.

This disclosure describes systems and methods for determining a camera trajectory for video stabilization when the camera is used to capture a series of images (e.g., video). Such systems and methods are less computationally expensive than 3D traditional transforms and can produce more accurate results (more robust) than 2D transformations for scenes having objects at various depths.

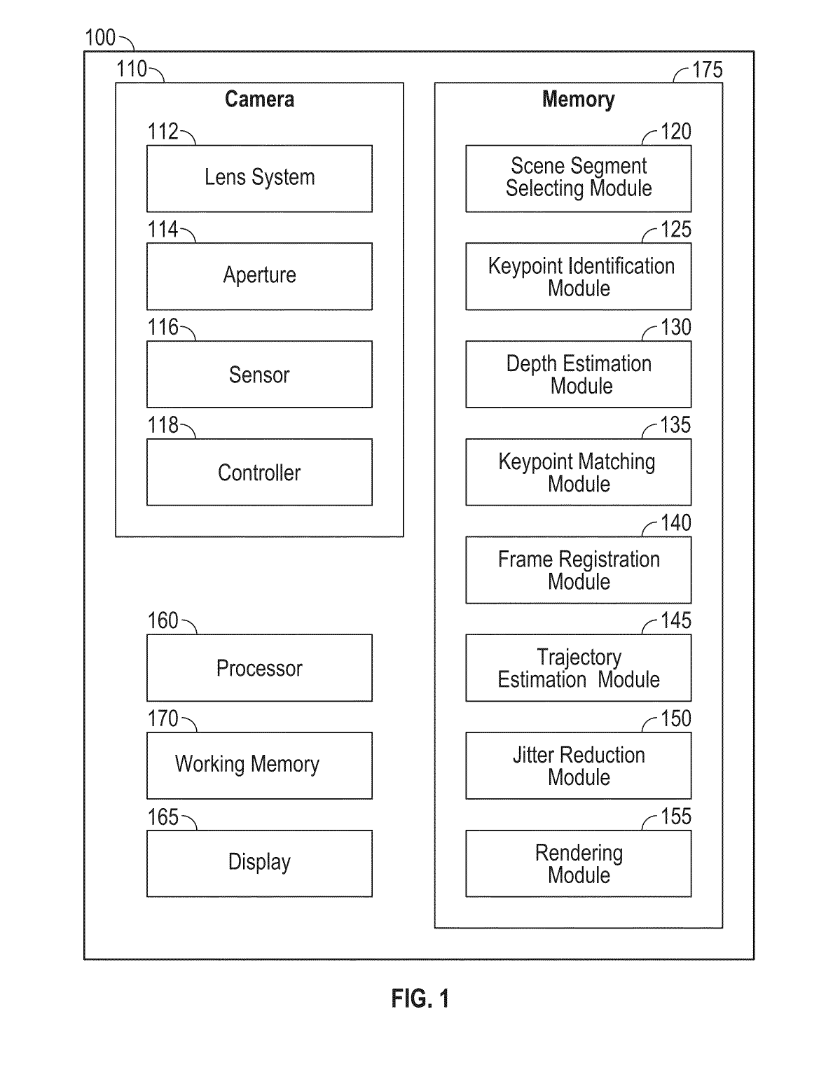

FIG. 1 is a block diagram illustrating an example embodiment of an imaging system 100 that is configured to stabilize video. Embodiments of the imaging system 100 may include, but are not limited to, a tablet computer, camera, wearable camera or computer, a cell phone a laptop computer, and mobile communication devices.

As illustrated in FIG. 1, the imaging system 100 includes a processor 160, a camera 110 and working memory 170. The processor 160 is in communication with the working memory 170 and the camera 110. The working memory 170 may be used to store data currently being accessed by the processor 160, and be a part of the processor 160 or a separate component. In the illustrated embodiment, the imaging system 100 may also include a separate memory 175 that includes instructions that are depicted and described in various modules to perform certain functionality for video stabilization, as described herein. In this example, memory 175 includes a scene segment selecting module 120, a keypoint identification module 125, a depth estimation module 130, a keypoint matching module 135, a frame registration module 140, a trajectory estimation module 145, a jitter reduction module 150, and a rendering module 155. The functionality of these modules 120, 125, 130, 135, 140, 145, 150 and 155 in memory 175 may be performed on the processor 160. The functionality of the modules 120, 125, 130, 135, 140, 145, 150 and 155 may, in other embodiments, be combined in various ways other than what is illustrated in FIG. 1. For example, such functionality may be described as being in more modules, or fewer modules (for example a single module) than what is illustrated in FIG. 1. These modules are further discussed herein below.

The camera 110 is configured to capture a plurality of images in a series (for example, video) of a scene or an object in a scene. A single image or one of the plurality of images in a series may be referred to herein as a “frame.” In some embodiments, the camera 110 is a single imaging device for capturing an image, for example, having a single image channel (or a single optical path). In some embodiments, the camera 110 has at least two imaging devices (for example, two imaging devices) and has at least two image channels (and/or at least two optical paths), and is configured to capture stereo image pairs of a scene. In such implementations, the at least two imaging devices are separated by a known distance. The lens system 112 focuses incident light onto an image sensor 116 of the imaging system 100. The lens system 112 for a single channel camera may contain a single lens or lens assembly. The lens system 112 for a stereo camera, may have two lenses (or lens assemblies) separated by a distance to enable capturing light, from the same point of an object, at different angles.

Still referring to the embodiment of FIG. 1, the camera 110 also includes an aperture 114, a sensor 116, and a controller 118. The controller 118 may have a processor (not shown). The controller 118 may control exposure (and/or the exposure period) of incident light through the lens system 112 onto sensor 116, and other camera 110 operations. For example, the controller 118 may operably control movement of the lens 112 (or at least one lens element) for focusing, control the size of the aperture 114 and/or how long the aperture 114 is open to control exposure (and/or the exposure period), and/or control sensor 116 properties (for example, gain). In some embodiments, a processor 160 of the imaging system 100 may be used to control the operations of the camera 110 instead of the controller 118. The controller 118 may be in communication with the processor 160 and other functional modules and structure of the imaging system 100.

The sensor 116 is configured to rapidly capture an image. In some embodiments, the sensor 116 comprises rows and columns of picture elements (pixels) that may use semiconductor technology, such as charged couple device (CCD) or complementary metal oxide semiconductors (CMOS) technology, that determine an intensity of incident light at each pixel during an exposure period for each image frame. In some embodiments, incident light may be filtered to one or more spectral ranges to take color images.

Embodiments of the imaging system 100 may include various modules to perform video stabilization. In the embodiment illustrated in FIG. 1, the imaging system 100 may include the scene segment selecting module 120 which is configured to select a segment (or portion) of the scene (which may be referred to herein as a “scene segment”) for video stabilization. In other words, a scene segment represents at least a portion of a scene captured in a plurality of captured images of the scene. For example, the scene segment represents a portion of a scene that includes an object. Selecting the scene segment may be done by determining (or selecting) a number of pixels in an image of the scene that represent or depict the desired portion of the scene. For some embodiments, display 165 includes a touchscreen. If the display 165 includes a touchscreen, the imaging system 110 can be configured such that a user may select a scene segment via display 165 of imaging system 100. In this way, the user may select an object of interest for stabilization across a plurality of images that depict the object. The scene segment selecting module 120 may receive information related to the user input from the display 165 and sets the outline of the scene segment based on an input (for example, a selection or coordinates) entered by the user on the display 165. In some embodiments, the user may select (by touching) an object displayed on the display 165, and the scene segment selecting module 120 may select a portion of the scene (sometimes referred to herein as a “scene segment” or simply “segment”) that includes the selected object. In some implementations, a user may use a multi-touch input on the display 165 to select a segment (or portion) of the frame for stabilization, and the scene segment selecting module 120 may select a scene segment that includes the segment selected by the user.

Still referring to FIG. 1, in some embodiments, the scene segment selecting module 120 is configured to select a segment of the scene for video stabilization automatically, independent of user input. For example, the scene segment selecting module 120 may be configured to use one or more image processing techniques to select a portion of a scene that may include a background region of the scene, a near object, and/or a segment with one or more identifiable features.

The scene segment selecting module 120 may be configured to, and operates to, use one or more image processing techniques to identify moving objects. Once identified, the scene segment selecting module 120 may determine scene segments for stabilization that do not include moving objects. In some implementations, the scene segment selecting module 120 may be configured to modify a segment selected for stabilization to exclude moving objects.

The imaging system 100 may also include a keypoint identification module 125 that is configured to, and operates to, detect one or more keypoints in an image corresponding to corner pixels of objects in a frame (for example, collectively with the processor 160). That is, a keypoint may be a pixel, location, or group of pixels in a frame that represents and/or correspond to the location in the image of an object or feature depicted in the image. A keypoint may correspond to an identifiable point or location in an image of a scene. In other words, each candidate keypoint may be a set of one or more pixels of an image that correspond to a feature (or object) in a scene, and that exist in at least some of the plurality of images. Keypoints may have image discontinuities (or variations) in more than one direction, and therefore may be thought of as “corners” indicating that there is an x and y change that is identifiable. Keypoints that occur in two frames, and that are from objects that are not moving, may be used to help determine camera translations or rotations between frames.

For some implementations, the keypoint identification module 125 is configured to, and operates to, down-sample video frames and process the down-sampled frames. This reduces the computational load and complexity of detecting keypoints. For some implementations, the keypoint identification module 125 down-samples the frames to one fourth their original size in each dimension. For other implementations, the keypoint identification module 125 may down-sample the frames to one half, one eight, or one sixteenth their original resolution.

The imaging system 100 may also include a depth estimation module 130 that is configured to, and operates to, generate depth estimates at keypoints. The resultant depth estimates form a coarse depth map. For some implementations, the depth map is generated using structured light. For some implementations, the depth map is generated using stereo imaging.

Still referring to FIG. 1, the illustrated imaging apparatus 100 may also include a keypoint matching module 135 that is configured to, and operates to, match keypoints between frames so that movement of the keypoint from one frame to the next may be characterized in a frame-pair transformation.

The illustrated imaging system 100 may also include a frame registration module 140 that is configured to, and operates to, extract frame-pair transforms to model scene changes due movement of the camera 110. Such camera movement may include translation from one location to another location. Camera movement may include, but is not limited to, rotation about an axis, or a change in pointing angle. The camera movements are associated with both desired movement, such as smooth scanning, and undesired movement, such as jitter. To remove unintended camera movement while retaining intended camera movement, the frame registration module 140 may be configured to determine the positions of the camera 110 that correspond to a set of captured video frames (for example, a plurality of images, a series of video frames). In other words, the frame registration module 140 may determine a set of camera positions, each camera position in the set corresponding to the position of the camera when the camera captured one of the video frames in the set of video frames. These positions of the camera 110 together may represent (or be used to define) a trajectory that indicates movement of the camera 110 when it captured the set of video frames. To characterize the movement of the camera 110 from frame to frame, frame to frame transforms may be used to estimate parameters that describe the movement from a first position of the camera 110 when it captures a first frame to a second position of the camera 110 when it captures a second frame. The parameters may include translation in each direction, rotation around various axes, skew, and/or other measures that define the movement.

In some embodiments, the parameters may be estimated using at least one sensor on the camera, for example, at least one inertial sensor. However, because accurate inertial sensors may be expensive or take up too much space, lower cost handheld cameras may characterize camera movement by determining the (apparent) movement of keypoints as depicted in a set of captured video frames. By matching keypoints and determining movement of a keypoint from a first frame to a second frame, the frame registration module 140 may estimate various aspects of camera movement, including for example, translation, rotation, scale changes, skew, and/or other movement characteristics. A frame-pair transform is the temporal transformation between two consecutive video frames, in a 2D transformation that characterizes the movement of the camera's position from one frame to the next. For some embodiments, the frame-pair transform is a full homography with eight degrees of freedom where the eight degrees of freedom correspond to eight parameters to be estimated to characterize movement. For some embodiments, the frame-pair transform is an affine transform with six degrees of freedom. Estimating more parameters accurately may require more measured keypoints and more computations.

As an example of a transform that may be used, the frame registration module 140 may use a similarity transform S with four degrees of freedom, for example, as shown below in equation (1), to transform coordinates (x, y) to (x′, y′) according to equation 1, where:

(x′ y′ 1)=(x y 1)S (1)

Transform S is a four degree of freedom transformation, for which k a scaling parameter, R a rotation matrix, and [tₓ t_{y}] represent an offset in an x (tₓ) direction and a y (t_{y}) direction according to equation (2), where:

$$S = [ \begin{matrix} & 0 \\ [ kR ] & 0 \\ [ \begin{matrix}{t}_{x} & {t}_{y}\end{matrix} ] & 1\end{matrix} ] \qquad ( 2 )$$

Rotation matrix R relates to rotation angle φ according to equation (3), where:

$$R = [ \begin{matrix}cos ϕ & sin ϕ \\ - sin ϕ & cos ϕ\end{matrix} ] \qquad ( 3 )$$

By substituting R into equation (2), transform S is defined according to equation (4), where:

$$S = [ \begin{matrix}k cos ϕ & k sin ϕ & 0 \\ - k sin ϕ & k cos ϕ & 0 \\ {t}_{x} & {t}_{y} & 1\end{matrix} ] \qquad ( 4 )$$

By substituting S into equation (1), the transformation of equation (1) is defined according to equation (5):

$$( \begin{matrix}{x}^{′} & {y}^{′} & 1\end{matrix} ) = ( \begin{matrix}x & y & 1\end{matrix} ) [ \begin{matrix}k cos ϕ & k sin ϕ & 0 \\ - k sin ϕ & k cos ϕ & 0 \\ {t}_{x} & {t}_{y} & 1\end{matrix} ] \qquad ( 5 )$$

In some embodiments, the frame registration modules 140 may use a similarity transform (4 degrees of freedom (DOF)) instead of a full homography (8 DOF) because it may be more robust in cases where few keypoints are available. Even with outlier rejection high-DOF, homographies can over-fit to noisy data (for example, too closely follow the noisy data) and produce poor results.

Under a pinhole camera model assumption, a frame-pair transform such as a homography or similarity transform is valid to map projected points from one frame to the next only if they are coplanar, or substantially co-planar. Depth discontinuities may pose a problem when estimating the transform parameters, as points from either side of the discontinuity cannot be modeled with the same transform. Accordingly, the frame registration module 140 can be configured to use an outlier rejection technique, for example, random sample consensus (RANSAC), when estimating the similarity transform for more robust estimates of S.

For some implementations, the frame registration module 140 uses depth information to only select keypoints that lie substantially on the same plane. The frame registration module may select a depth for the plane based on the camera focus parameters, a user's tap-to-focus input on display 165, a user's tap-to-stabilize input on display 165, or default in the background of the selected scene segment.

Some embodiments use stereo images to determine the depth of object or keypoints in an image. Given two consecutive stereo frames, the keypoint identification module 125 may be configured to identify candidate keypoints and their descriptors in the left image of frame n−1. Depth estimation module 130 may then estimate the horizontal displacement in the right image of the same frame, which indicates the depth of the keypoints. Then, the keypoint matching module 135 may select candidate keypoints according to a target depth for the stabilization, and match keypoints from the right stereo image to keypoints in the left image of the subsequent frame n. For some embodiments, the keypoint matching module 135 may select those keypoints within a depth tolerance value of a target depth. In other words, within a plus/minus depth range around a target depth. The keypoint matching module 135 may adjust the target depth and depth tolerance value in response to estimated depths of the candidate keypoints. The keypoint matching module 135 may select keypoints through a process of de-selecting those candidate keypoints that are not within a depth tolerance value of the target depth.

Frame registration module 140 may estimate a similarity transform Sₙ that describes a mapping from frame n−1 to n (for example, using a RANSAC approach) to estimate the transform, drawing a minimum subset of keypoint correspondences at each iteration and counting the number of inliers with an error of less than 1.5 pixels.

Still referring to the embodiment illustrated in FIG. 1, the trajectory estimation module 145 is configured to use frame-pair transform parameters to estimate a trajectory representing positions of the camera 110 when capturing the video frames. The similarity transforms S for frame n, Sₙ, describes the mapping of the image between consecutive frames n−1 and n. The trajectory estimation module 145 may be configured to determine a cumulative transform Cₙ of the camera 110 starting at the beginning of the sequence according to equation (6):

Cₙ=S₁S₂ . . . Sₙ (6)

where S₁ is initiated as the unity transform. Cₙ may be calculated recursively for n>1 as shown in equation (7):

Cₙ=Cₙ₋₁Sₙ (7)

The jitter reduction module 150 is configured to, and operates to, compute parameters for smoothed frame-pair transforms to remove jitter, for example, from the trajectory of the camera positions, while maintaining intentional panning and rotation of the camera 110. A second trajectory may be determined that represents a set of adjusted positions of the camera. In some embodiments, the adjusted positions are determined by smoothing the second trajectory. Such smoothing may remove, or diminish, jitter while maintaining intended camera movements. In some embodiments, the jitter reduction module 150 may use an infinite impulse response (IIR) filter to compute the smoothed transform. Smoothing by using an IIR filtering may be computed on the fly while the sequence is being processed at much lower computational costs than more complex smoothing approaches.

Still referring to FIG. 1, in some embodiments a jitter reduction module 150 is configured to decompose the cumulative transform Cₙ at frame n into its scaling parameter k, rotation angle φ, horizontal and vertical offsets tₓ and t_{y}, respectively. The jitter reduction module 150 may use the following approach to estimate each of these four parameters.

For the scaling parameter k, where kₙ is the parameter at frame n, and [symbol] , is the smoothed parameter at frame n, the jitter reduction module 150 may compute equation (8):

[symbol]

=αₖkₙ₋₁+(1−αₖ)kₙ (8)

where αₖ controls the smoothening effect for the scaling parameter. For example, the jitter reduction module 150 may set αₖ=0.9.

For the rotation angle parameter φ, where φₙ is the parameter at frame n, and [symbol] is the smoothed parameter at frame n, the jitter reduction module 150 may compute equation (9):

[symbol]

=α_{φ}φₙ₋₁+(1−α_{φ})φₙ (9)

where α_{φ} controls the smoothening effect for the rotation angle parameter. For example, the jitter reduction module 150 may set α_{φ}=0.9.

For the horizontal offset parameter tₓ, where tₓ_{ₙ} is the parameter at frame n, and [symbol] is the smoothed parameter at frame n, the jitter reduction module 150 may compute equation (10):

[symbol]

=αₜ_{ₙ}tₓ_{ₙ₋₁}+(1−αₜ_{ₓ})tₓ_{ₙ} (10)

where αₜ_{ₓ} controls the smoothening effect for the horizontal offset parameter. For example, the jitter reduction module 150 may set αₜ_{ₓ}=0.9.

For the vertical offset parameter t_{y}, where t_{y}_{ₙ} is the parameter at frame n, and [symbol] is the smoothed parameter at frame n, the jitter reduction module 150 may compute equation (11):

[symbol]

=αₜ_{_{y}}t_{y}_{ₙ₋₁}+(1−αₜ_{_{y}})t_{y}_{ₙ} (11)

where αₜ_{_{y}} controls the smoothening effect for the vertical offset parameter. For example, the jitter reduction module 150 may set αₜ_{_{y}}=0.9.

The jitter reduction module 150 may use equations (12) and (13) for each frame n to determine the smoothed cumulative transforms [symbol] using the smoothed parameters [symbol] , [symbol] , [symbol] , and [symbol] .

$$\begin{matrix}= [ \begin{matrix} cos & sin & 0 \\ - sin & cos ϕ & 0 \\ & & 1\end{matrix} ] & ( 12 ) \\ = & ( 13 )\end{matrix}$$

Still referring to FIG. 1, in some embodiments, the rendering module 155 may be configured to re-generate the video sequence according to the smoothed transforms. Given the cumulative transforms Cₙ and their smooth versions [symbol] the rendering module 155 may compute a retargeting transform according to equation (14):

Tₙ=Cₙ [symbol] (14)

as the first frame of the original and the smoothed sequence are linked with an identity transform I. In some embodiments that use stereo imagery to determine the depth of candidate keypoints in the scene, the rendering module 155 may apply the same retargeting transform to both a left image and right image, as the two sensors that capture the left and right stereo images do not move with respect to each other. For some implementations where the two sensors have different resolutions, the rendering module 155 uses the higher resolution sequence.

The processor 160 is configured to, and operates to, process data and information. The processor 160 may process imagery, image data, control data, and/or camera trajectories. The modules described herein may include instructions to operate the processor 160 to perform functionality, for example the described functionality. For some embodiments, the processor 160 may perform (or process) scene segment selecting module 120 functionality, keypoint identification module 125 functionality, depth estimation module 130 functionality, keypoint matching module 135 functionality, frame registration module 140 functionality, trajectory estimation module 145 functionality, jitter reduction module 150 functionality, and/or rendering module 155 functionality.

As mentioned above, the imaging system 100 may also include a display 165 that can display images, for example, that are communicated to the display 165 from the processor 160. For some implementations, the display 165 displays user feedback, for example, annotations for touch-to-focus indicating selected frame segments. For some implementations, the display 165 displays menus prompting user input.

In some embodiments, the display 165 includes a touchscreen that accepts user input via touch. In some embodiments the imaging system 100 may input commands for example, the user may touch a point on the image to focus on, or input desired imaging characteristics or parameters. As mentioned above, in some implementations, a user may select a scene segment by, for example, selecting a boundary of a region.

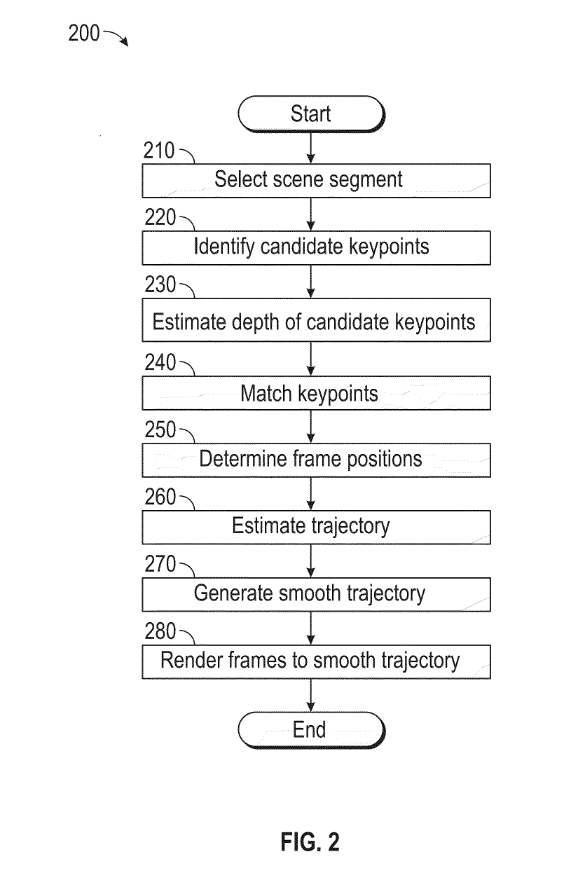

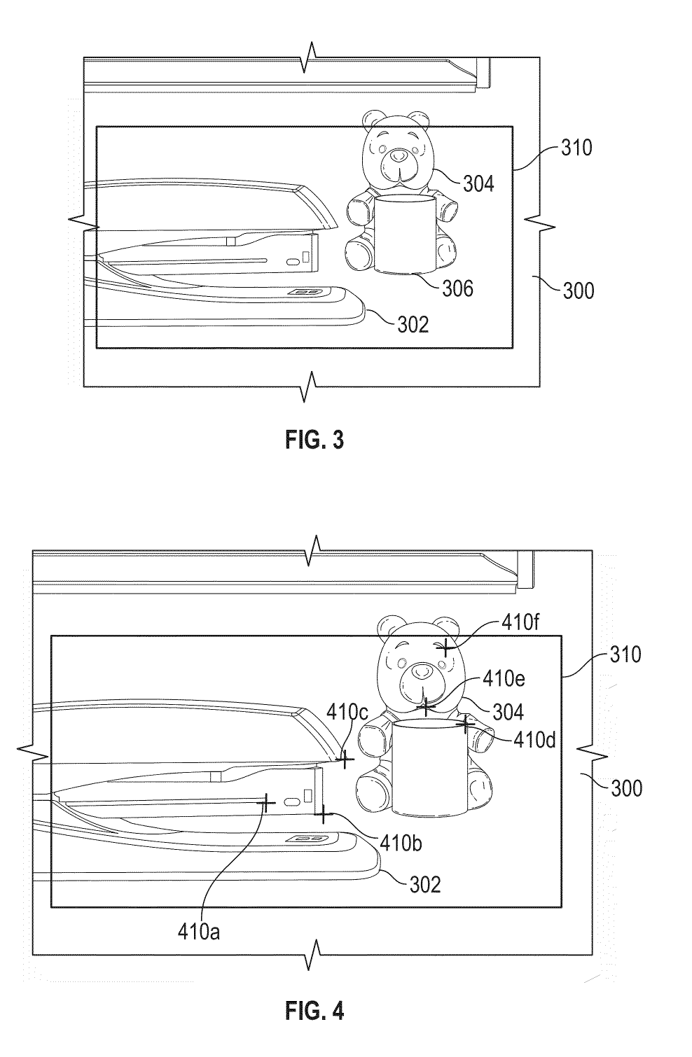

FIG. 2 is a flow chart that illustrates an example of a process 200 for stabilizing video. FIGS. 3-12 correspond with portions of process 200 and are referred to below in reference to certain blocks of process 210. Process 200 operates on a plurality of images, for example, a set (or series) of video frames, at least some of which being captured before process 200 operates as illustrated in FIG. 2. In some embodiments, the plurality of images are generated and stored in memory, and then accessed by process 200. For example, the plurality of images may be stored for a short time (for example, a fraction of a second, or a second or a few seconds) or stored for later processing (for example, for several seconds, minutes hours or longer).

At block 210 the process 200 determines a scene segment which will be used for video stabilization. The scene segment may be determined based on user input, automatically using image processing techniques, or a combination of user input and automatic or semi-automatic image processing techniques. As an example, FIG. 3 illustrates an image 300 that includes a stapler 302, a toy bear 304, and a cup 306. FIG. 3 also illustrates an example of a scene segment 310 determined (or selected) for video stabilization. In this example the scene segment 310 is rectangular-shape. A rectangular-shaped scene segment 310 may be relatively easy to implement and process. However, a scene segment is not limited to being rectangular-shaped and there may be some embodiments where it is preferred to use a scene segment that has a shape other than rectangular. As illustrated in FIG. 3, the scene segment 310 includes one or more objects in image 300 that may be of interest to a user, in this case a portion of the stapler 302, a portion of the bear 304, and the cup 306. In image 300, portions of the stapler 302 and the bear 304 are at different depths in the scene. In other words, portions of the stapler 302 and the bear 304 are positioned at different distances from an imaging device capturing an image (for example, video) of the scene. For some embodiments, the functionality of block 210 may be performed by the scene segment selecting module 120 illustrated in FIG. 1.

At block 220, the process 200 identifies candidate keypoints that are in the scene segment 310. The candidate keypoints may be portions of objects depicted in an image that have pixel values changing in at least two directions. The change in pixel values are indicative of an edge. For example, an intensity change in both an x (horizontal) direction and a y (vertical) direction (in reference to a rectangular image having pixels arranged in an horizontal and vertical array). The candidate keypoints may be, for example, corners of objects in scene segment 310. FIG. 4 illustrates six exemplary candidate keypoints (also referred to as “corners”) that are in scene segment 310, marked with a “+” symbol. As shown in FIG. 4, corner 410a is at the end of a slot in the stapler 302. Candidate keypoint 410b is at a corner of a component of the stapler 302. Candidate keypoint 410c is at the top front of the stapler 302. Candidate keypoint 410d is at the end of the cup 306 held by the bear 304. Candidate keypoint 410e corresponds to a corner of a facial feature of the bear 304. Candidate keypoint 410f is at the tip of an eyebrow of the bear 304. These candidate keypoints 410a, 410b, 410c, 410d, 410e, and 410f are groups of pixels that are on a “corner” of an object in the scene segment, that is, have discernable image changes at a location in the image indicating that there is an edge in two directions in the image. For example, a change in the x direction and a change in the y direction. Such discontinuities facilitate the process 200 to quickly and accurately determine corresponding candidate keypoints in consecutive frames. For some embodiments, the functionality of block 220 may be performed by the keypoint identification module 125 illustrated in FIG. 1.

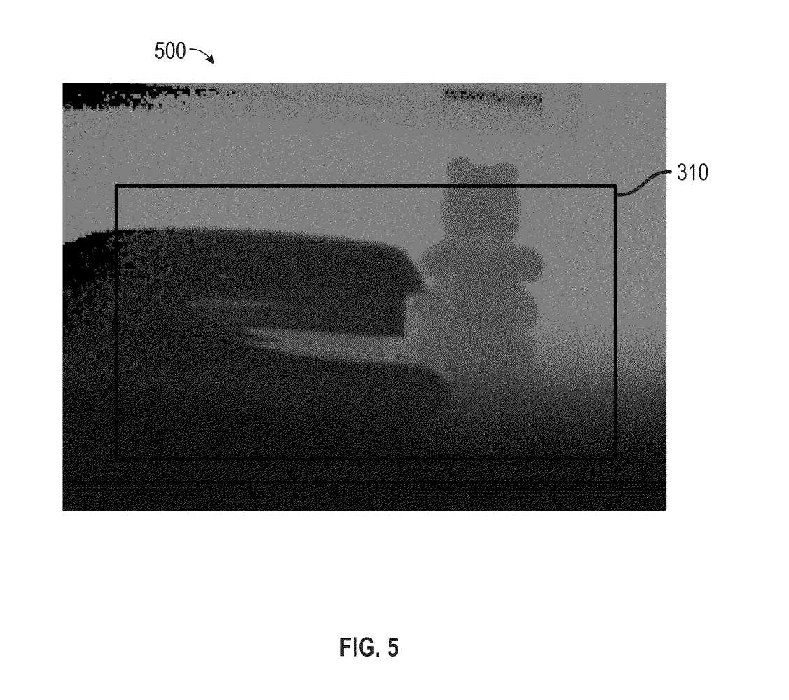

At block 230, the process 200 determines depth information (for example, a depth) of each of the candidate keypoints, in this example, candidate keypoints 410a, 410b, 410c, 410d, 410e, and 410f. In some embodiments, the process 200 may determine the depth of the candidate keypoints by first determining a depth map of the scene segment 310. In some embodiments, the process 200 may determine the depth of the candidate keypoints by using an existing depth map. A depth map may have been generated using a range finding techniques using stereo image pairs, or generated using an active depth sensing technique. An example of a depth map 500 of image 300 is illustrated in FIG. 5. FIG. 5 also illustrates the location of the scene segment 310 on the depth map 500 for reference. Once the depth of the candidate keypoints 410a, 410b, 410c, 410d, 410e, and 410f are determined, the process 200 can identify keypoints that will be matched image-to-image. In some embodiments, the identified keypoints are the candidate keypoints that are at the same depth (or substantially at the same depth) in the scene segment 310. For example, the keypoints 410a and 410b are candidate keypoints that are at a depth d, or within a certain depth tolerance value Ad of depth d. In other words, at depth d plus or minus Δd. The other keypoints 410c, 410d, 410e, and 410f are at different depths than 410a and 410b, and the depth values of these candidate keypoints may exceed the depth tolerance value. In some embodiments, the depth tolerance value is the same whether it is indicating a closer distance than depth d or a farther distance than depth d. In some embodiments, the depth tolerance value is different when indicating a depth closer to the camera or farther from the camera. For some embodiments, the functionality of block 230 may be performed by the depth estimating module 130 illustrated in FIG. 1.

In block 240, the process 200 matches keypoints that were identified in block 230 as being at the same depth from image-to-image, for example, keypoints 410a, 410b. In some embodiments, there are more than two keypoints. The process 200 uses image processing techniques to identify the location of corresponding keypoints in subsequent frames. A person having ordinary skill in the art will appreciate that many different techniques maybe used to find the same point in two images in a series of images of the same or substantially the same scene, including standardized techniques. In this example, keypoints 410a and 410b correspond to two points of the stapler 302 that are also identified in subsequent frames. The process 200 identifies the corresponding keypoints in at least two frames. The process 200 determines positions for each keypoint in each frame, and determines changes in position for each keypoint from one frame (image) to another subsequent frame (image). For some embodiments, the functionality of block 240 may be performed by the keypoint matching module 135 illustrated in FIG. 1.

At block 250, the process 200 determines frame positions corresponding to camera positions by aggregating the positional changes of the keypoints to determine the camera movement that occurred from image-to-image relative to the scene. For example if the camera translated to the right relative to the scene segment from a first image to a subsequent second image, then positions of keypoints in the second image appear to me moved to the left. If the camera translates up from a first image to a second image, keypoints in the second image appear to have moved down. If the camera was rotated counterclockwise around a center point from a first image to a second image, then keypoints appear to move clockwise around the center point as they appear in the second image.

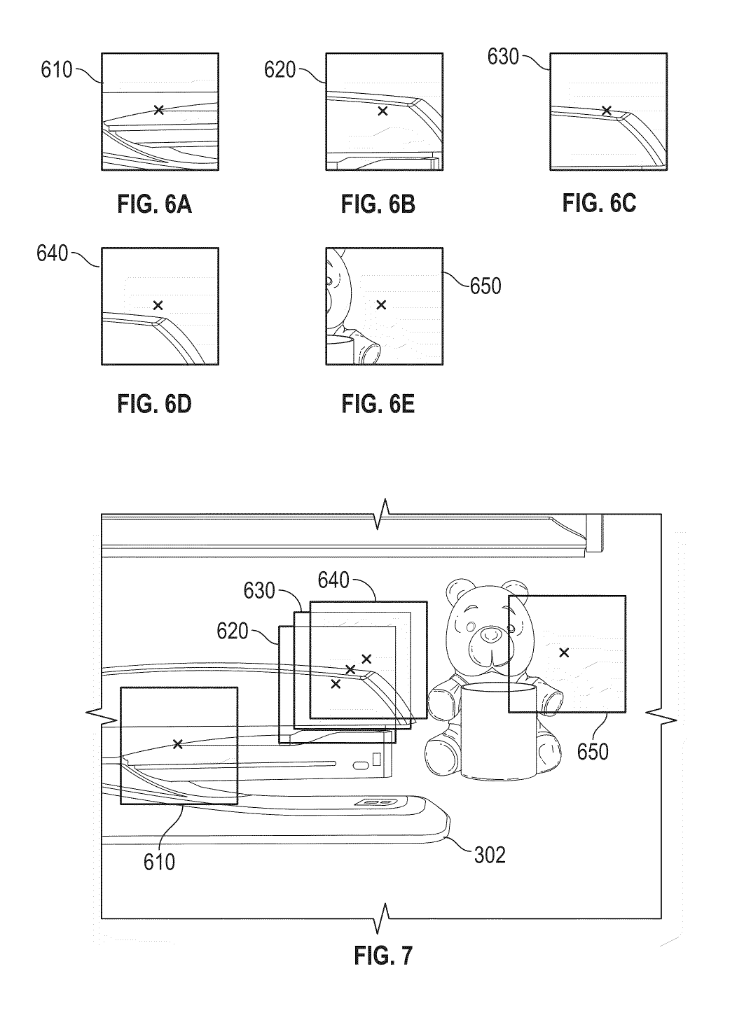

By considering the position of multiple keypoints to aggregate positional changes from image-to-image, the process 200 may estimate a similarity transform to characterize camera movement parameters for horizontal translation, vertical translation, rotation, and scaling differences. To further illustrate process 200, FIGS. 6A-6E are examples of portions of a series of images in a captured video, including a start frame 610, three consecutive frames 620, 630, and 640 and an end frame 650. Other frames captured between frame 610 and frame 650 are not shown for clarity of the figure. FIG. 7 illustrates the frames 610, 620, 630, 640 and 650 overlaid on a depiction of the scene. Any intervening frames are not shown for clarity. An X marks the middle of each captured frame. The process 200 determines a similarity transform that characterizes rotation and offset from frame-to-frame for each of frames 610, 620, 630, 640 and 650. In some embodiments, the functionality of block 250 may be performed by the frame registration module 140 illustrated in FIG. 1.

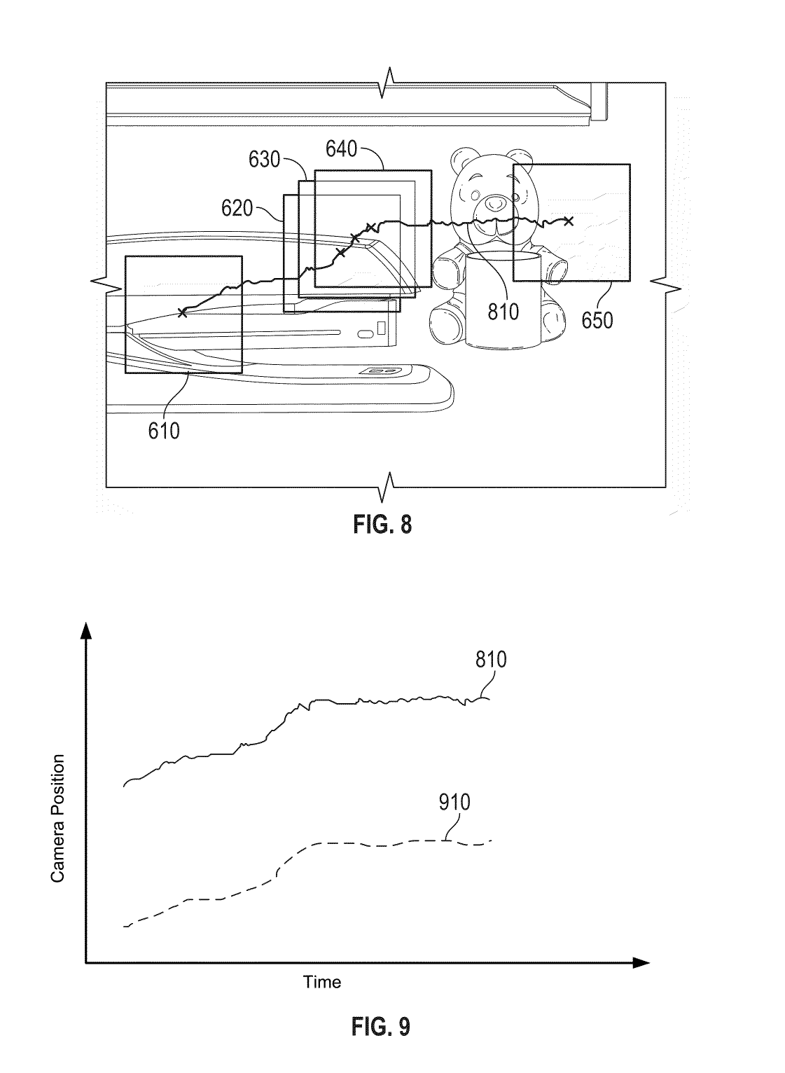

In block 260, the process 200 determines a trajectory representing the position of the camera based on the camera movement parameters determined in block 250. FIG. 8 illustrates an estimated trajectory 810, which indicates a camera position when the camera captured each frame in a series of frames starting with frame 610, continuing to frames 620, 630, and 640, and ending with frame 650. As can be seen in this example, the trajectory 810 appears to have high-frequency changes which indicate small positional changes, or camera movements, when the camera was capturing the series of images. The high-frequency changes in the trajectory 810 likely indicate unintended movement of the camera. For some embodiments, the functionality of block 260 may be performed by the trajectory estimation module 145 illustrated in FIG. 1.

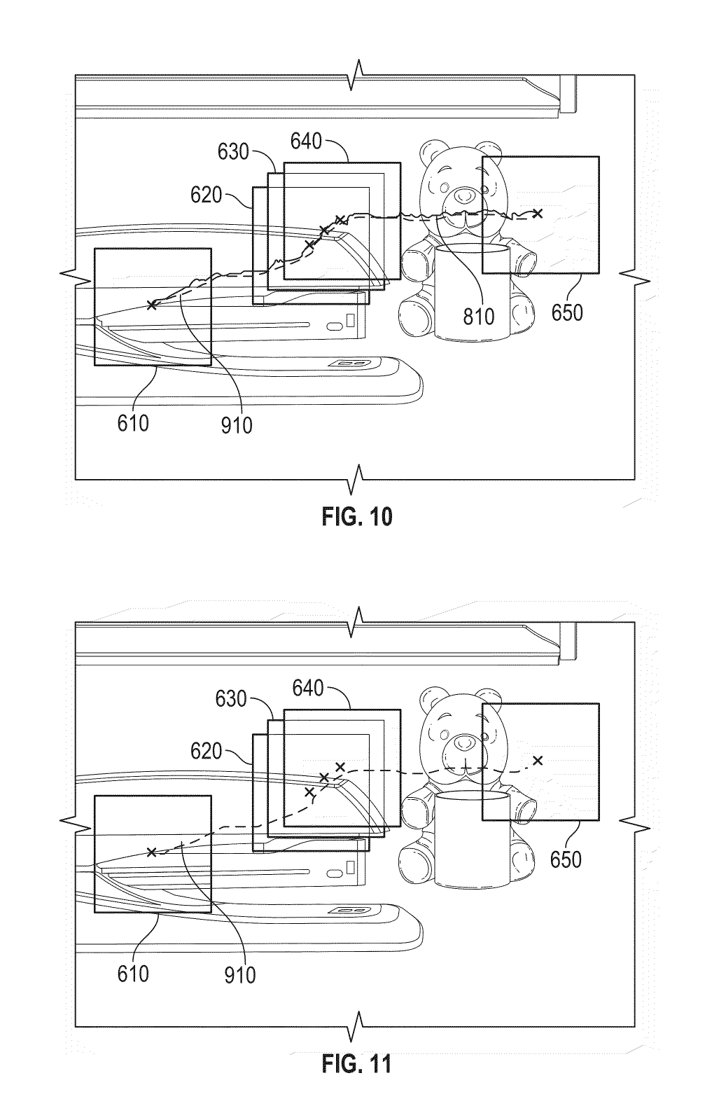

In block 270, the process 200 generates a smooth trajectory from the trajectory with jitter. FIG. 9 is a graph illustrating the trajectory 810 of the camera that captured the frames in FIG. 7, with “time” being along the x-axis and “camera position” being along the y-axis. The trajectory 810 exhibits high frequency motion (for example, jitter). The graph in FIG. 9 also illustrates a smoothed trajectory 910 that represents movement of the camera as stabilized. That is, the smoothed trajectory 910 is based on the trajectory 810, and has been processed to remove the jitter but maintain other camera movements (for example, intentional camera movements). FIG. 10 illustrates the trajectory 810 of the camera that captured the frames in FIG. 7 with jitter, and the smoothed trajectory 910 after video stabilization, superimposed on the image scene. The centers of the frames lie on the camera trajectory 810, but do not necessary lie on the smoothed trajectory 910. For some embodiments, the process 200 may generate the smoothed trajectory 910 by filtering the camera trajectory 810 using an infinite impulse response (IIR) filter. For some embodiments, the functionality of block 270 may be performed by the jitter reduction module 150 illustrated in FIG. 1.

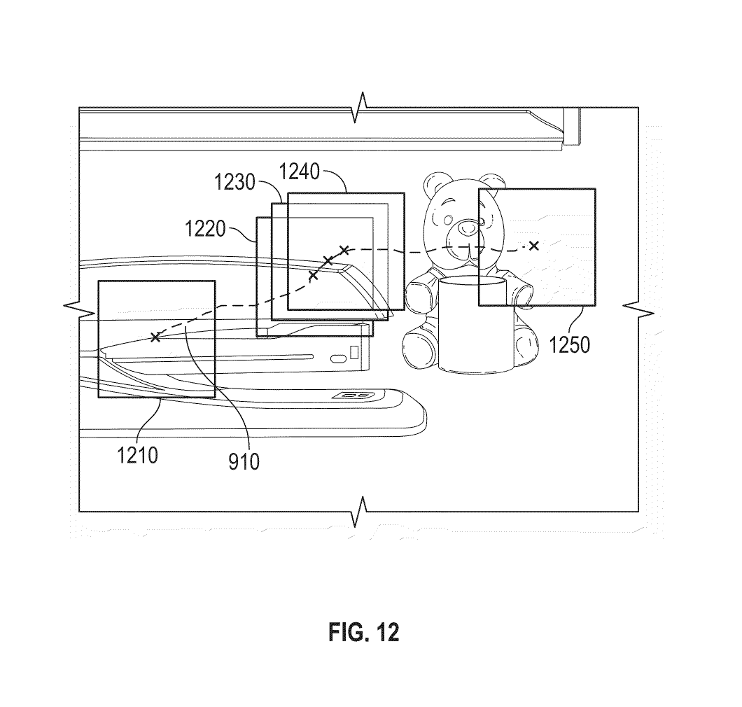

In block 280, the process 200 renders frames based on the smooth trajectory. FIG. 11 illustrates the smoothed trajectory 910 (FIG. 9) before the frames are rendered to the smoothed trajectory 910. The center points of the frames are in some cases offset from the trajectory. FIG. 12 illustrates the re-rendered frames along the smoothed trajectory 910. Re-rendered frames 1210, 1220, 1230, 1240, and 1250 correspond in time to frames 610, 620, 630, 640, and 650, respectively. After rendering, the center points of the frames 1210, 1220, 1230, 1240, and 1250 are on the smoothed trajectory. The rendering module 155 re-renders the video to smoothed trajectory 910. In some embodiments, a rendering module 155 (FIG. 1) is configured to use the similarity transform parameters and the difference in position and trajectory to calculate the necessary translation, rotation, and scaling to apply to the captured image at the timeslot to render the stabilized video frame. For example, if the similarity transform indicates a translation of one (1) pixel to the left, then the rendering module 155 translates the captured video by one pixel to render the stabilized video frame. The rendering module 155 may render fractional pixel translations by interpolation.

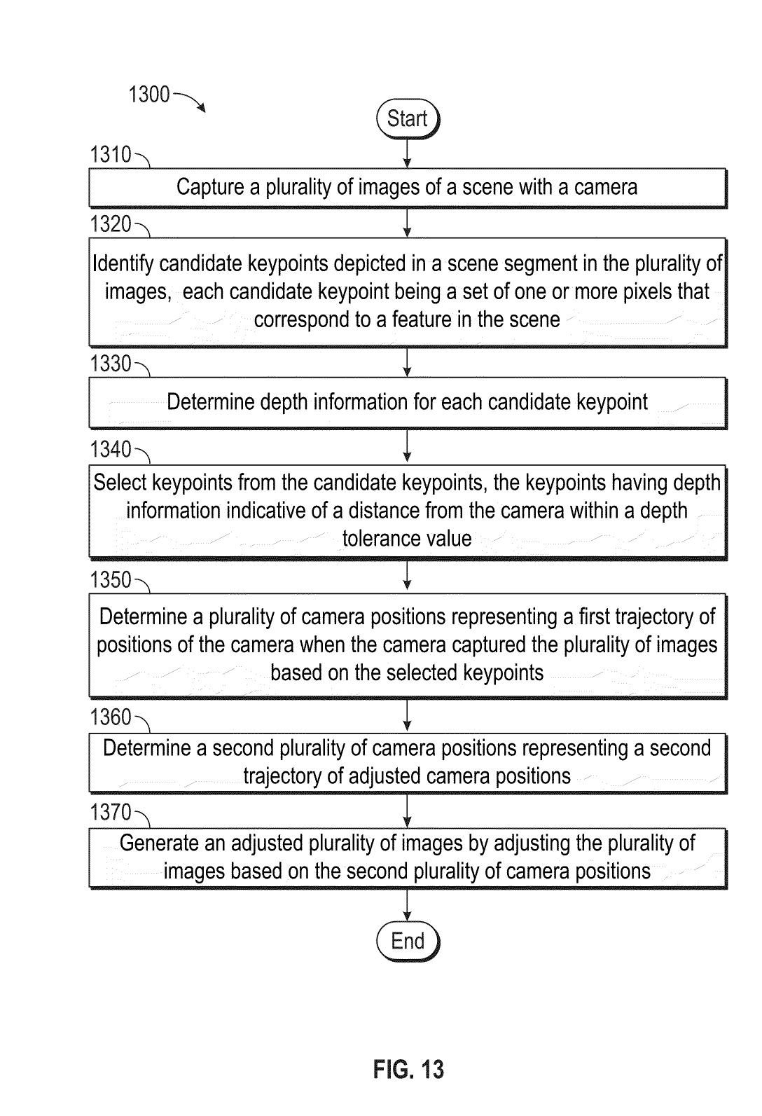

FIG. 13 is a flowchart that illustrates an example of a process for video stabilization according to the embodiments described herein. At block 1310, the process 1300 captures a plurality of images of a scene with a camera. In some implementations, the functionality of block 1310 may be performed by the camera 110 illustrated in FIG. 1. At block 1320, the process 1300 identifies candidate keypoints in the plurality of images, each candidate keypoint depicted in a scene segment that represents a portion of the scene, each candidate keypoint being a set of one or more pixels that correspond to a feature in the scene and that exists in the plurality of images. In some implementations, the functionality of block 1320 may be performed by the keypoint identification module 125 illustrated in FIG. 1.

At block 1330 the process 1300 determines depth information for each candidate keypoint. In some implementations, the functionality of block 1330 may be performed by the depth estimation module 130 illustrated in FIG. 1. At block 1340, the process 1300 selects keypoints from the candidate keypoints, the keypoints having depth information indicative of a distance from the camera within a depth tolerance value. In some implementations, the functionality of block 1340 may be performed by the keypoint matching module 135 illustrated in FIG. 1.

At block 1350, the process 1300 determines a plurality of camera positions based on the selected keypoints, each camera position representing a position of the camera when the camera captured one of the plurality of images, the plurality of camera positions representing a first trajectory of positions of the camera when the camera captured the plurality of images. In some implementations, the functionality of block 1350 may be performed by the frame registration module 140 and the trajectory estimation module 145 illustrated in FIG. 1. At block 1360, the process 1300 determines a second plurality of camera positions based on the first camera positions, each one of the second plurality of camera positions corresponding to one of the first camera positions, the plurality of second camera positions representing a second trajectory of adjusted camera positions. In some implementations, the functionality of block 1360 may be performed by the jitter reduction module 150 illustrated in FIG. 1.

At block 1370, the process 1300 generates an adjusted plurality of images by adjusting the plurality of images based on the second plurality of camera positions. In some implementations, the functionality of block 1370 may be performed by the rendering module 145 illustrated in FIG. 1.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner.

Also, unless stated otherwise a set of elements may comprise one or more elements. In addition, terminology of the form “at least one of: A, B, or C” used in the description or the claims means “A or B or C or any combination of these elements.”

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein.

A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims. The functions described may be implemented in hardware, software, firmware or any combination thereof. If implemented in software, the functions may be stored as one or more instructions on a computer-readable medium.

A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or Universal Serial Bus (USB) Flash memory, Secure Digital (SD) memory, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An imaging apparatus, comprising:
a memory component configured to store a plurality of images;
a processor in communication with the memory component, the processor configured to
retrieve a plurality of images from the memory component;
identify candidate keypoints in the plurality of images, each candidate keypoint depicted in a scene segment that represents a portion of the scene, each candidate keypoint being a set of one or more pixels that correspond to a feature in the scene and that exists in the plurality of images;
determine depth information for each candidate keypoint, the depth information indicative of a distance from a camera to the feature corresponding to the candidate keypoint;
select keypoints from the candidate keypoints, the keypoints having depth information indicative of a distance from the camera within a depth tolerance value;
determine a first plurality of camera positions based on the selected keypoints, each one of the first plurality of camera positions representing a position of the camera when the camera captured one of the plurality of images, the first plurality of camera positions representing a first trajectory of positions of the camera when the camera captured the plurality of images;
determine a second plurality of camera positions based on the first plurality of camera positions, each one of the second plurality of camera positions corresponding to one of the first plurality of camera positions, the second plurality of camera positions representing a second trajectory of adjusted camera positions; and
generate an adjusted plurality of images by adjusting the plurality of images based on the second plurality of camera positions.

2. The imaging apparatus of claim 1, further comprising a camera capable of capturing the plurality of images, the camera in electronic communication with the memory component.

3. The imaging apparatus of claim 1, wherein the processor is further configured to:
determine the second plurality of camera positions such that the second trajectory is smoother than the first trajectory; and
store the adjusted plurality of images.

4. The imaging apparatus of claim 1, further comprising a user interface comprising a display screen capable of displaying the plurality of images.

5. The imaging apparatus of claim 4, wherein the user interface further comprises a touchscreen configured to receive at least one user input, and wherein the processor is further configured to receive the at least one user input and determine the scene segment based on the at least one user input.

6. The imaging apparatus of claim 1, wherein the processor is configured to determine the scene segment based on content of the plurality of images.

7. The imaging apparatus of claim 1, wherein the processor is configured to determine the depth of the candidate keypoints during at least a portion of the time that the camera is capturing the plurality of images.

8. The imaging apparatus of claim 1, wherein the camera is configured to capture stereo imagery.

9. The imaging apparatus of claim 8, wherein the processor is configured to determine the depth of each candidate keypoint from the stereo imagery.

10. The imaging apparatus of claim 1, wherein the candidate keypoints correspond to one or more pixels representing portions of one or more objects depicted in the plurality of images that have changes in intensity in at least two different directions.

11. The imaging apparatus of claim 1, wherein the processor is further configured to determine the relative position of a first image of the plurality of images to the relative position of a second image of the plurality of images via a two dimensional transformation using the selected keypoints of the first image and the second image.

12. The imaging apparatus of claim 11, wherein the two dimensional transformation is a transform having a scaling parameter k, a rotation angle φ, a horizontal offset tₓ and a vertical offset t_{y}.

13. The imaging apparatus of claim 1, wherein determining the second trajectory of camera positions comprises smoothing the first trajectory of camera positions.

14. A method of stabilizing video, the method comprising:
capturing a plurality of images of a scene with a camera;
identifying candidate keypoints in the plurality of images, each candidate keypoint depicted in a scene segment that represents a portion of the scene, each candidate keypoint being a set of one or more pixels that correspond to a feature in the scene and that exists in the plurality of images;
determining depth information for each candidate keypoint;
selecting keypoints from the candidate keypoints, the keypoints having depth information indicative of a distance from the camera within a depth tolerance value;
determining a first plurality of camera positions based on the selected keypoints, each of the first plurality of camera positions representing a position of the camera when the camera captured one of the plurality of images, the first plurality of camera positions representing a first trajectory of positions of the camera when the camera captured the plurality of images;
determining a second plurality of camera positions based on the first plurality of camera positions, each one of the second plurality of camera positions corresponding to one of the first plurality of camera positions, the second plurality of camera positions representing a second trajectory of adjusted camera positions; and
generating an adjusted plurality of images by adjusting the plurality of images based on the second plurality of camera positions.

15. The method of claim 14, wherein the second plurality of camera positions are determined such that the second trajectory is smoother than the first trajectory.

16. The method of claim 15, further comprising:
storing the plurality of images captured by the camera in a memory component; and
storing the adjusted plurality of images.

17. The method of claim 14, further comprising:
displaying the plurality of images on a user interface;
receiving at least one user input from the user interface; and
determining the scene segment based on the at least one user input.

18. The method of claim 14, further comprising determining the scene segment automatically.

19. The method of claim 14, wherein capturing a plurality of images comprises capturing stereo imagery of the scene.

20. The method of claim 19, wherein determining a depth of each candidate keypoint comprises determining the depth based on the stereo imagery.

21. The method of claim 14, wherein determining depth information for each candidate keypoint comprises generating a depth map of the scene.

22. The method of claim 14, wherein the processor is further configured to determine the relative position of a first image of the plurality of images to the relative position of a second image of the plurality of images via a two dimensional transformation using the selected keypoints of the first image and the second image.

23. The method of claim 22, wherein the two dimensional transformation is a homography transform having a scaling parameter k, a rotation angle φ, a horizontal offset tₓ and a vertical offset t_{y}.

24. The method of claim 15, wherein determining the second trajectory of camera positions comprises smoothing the first trajectory of camera positions.

25. An imaging apparatus, comprising:
means for capturing a plurality of images of a scene with a camera;
means for identifying candidate keypoints in the plurality of images, each candidate keypoint depicted in a scene segment that represents a portion of the scene, each candidate keypoint being a set of one or more pixels that correspond to a feature in the scene and that exists in the plurality of images;
means for determining depth information for each candidate keypoint;
means for selecting keypoints from the candidate keypoints, the keypoints having depth information indicative of a distance from the camera within a depth tolerance value;
means for determining a first plurality of camera positions based on the selected keypoints, each of the first plurality of camera positions representing a position of the camera when the camera captured one of the plurality of images, the first plurality of camera positions representing a first trajectory of positions of the camera when the camera captured the plurality of images;
means for determining a second plurality of camera positions based on the first plurality of camera positions, each one of the second plurality of camera positions corresponding to one of the first plurality of camera positions, the second plurality of camera positions representing a second trajectory of adjusted camera positions; and
means for generating an adjusted plurality of images by adjusting the plurality of images based on the second plurality of camera positions.

26. The imaging apparatus of claim 25, further comprising means for storing the second plurality of camera positions.

27. The imaging apparatus of claim 25, further comprising means for displaying a plurality of images.

28. The imaging apparatus of claim 27, wherein the means for displaying a plurality of images comprises means for receiving at least one user input, and wherein the imaging apparatus further comprises means for determining the scene segment based on the at least one user input.

29. The imaging apparatus of claim 25, further comprising means for determining the scene segment based on a content of the plurality of images.

30. A non-transitory computer-readable medium storing instructions for generating stabilized video, the instructions when executed that, when executed, perform a method comprising:
capturing a plurality of images of a scene with a camera;
identifying candidate keypoints in the plurality of images, each candidate keypoint depicted in a scene segment that represents a portion of the scene, each candidate keypoint being a set of one or more pixels that correspond to a feature in the scene and that exists in the plurality of images;
determining depth information for each candidate keypoint;
selecting keypoints from the candidate keypoints, the keypoints having depth information indicative of a distance from the camera within a depth tolerance value;
determining a first plurality of camera positions based on the selected keypoints, each of the first plurality of camera positions representing a position of the camera when the camera captured one of the plurality of images, the first plurality of camera positions representing a first trajectory of positions of the camera when the camera captured the plurality of images;
determining a second plurality of camera positions based on the first plurality of camera positions, each one of the second plurality of camera positions corresponding to one of the first plurality of camera positions, the second plurality of camera positions representing a second trajectory of adjusted camera positions; and
generating an adjusted plurality of images by adjusting the plurality of images based on the second plurality of camera positions.
